(19) United States
(12) Patent Application Publication
(10) Pub. No.: US 2026/0114418 A1
(43) Pub. Date: Apr. 30, 2026

(54) CAT LITTER BOX AND CAT LITTER BIN THEREOF

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/367,339

(22) Filed: Oct. 23, 2025

(30) Foreign Application Priority Data
Oct. 29, 2024 (CN) 202422619807.5

(51) Int. Cl. A01K 1/01

(52) U.S. Cl. CPC A01K 1/0107

(57) ABSTRACT

A cat litter box and a cat litter bin thereof are provided. The cat litter bin includes a main bin body, a bin bottom shell, and a silicone bin. An opening is defined in a bottom portion of the main bin body. The bin bottom shell includes a cover. A sealing flange extends out of the silicone bin along an edge of the silicone bin. The silicone bin is disposed on the bin bottom shell. Side walls of the cover of the bin bottom shell abut against a bottom portion of the sealing flange. When the bin bottom shell covers the opening, a top portion of the sealing flange abuts against side walls of the opening.

### TECHNICAL FIELD

The present disclosure relates to a field of pet products, in particular to a cat litter bin of a cat litter box and the cat litter box.

### BACKGROUND

Cat litter boxes are a new product that has emerged in recent years. The cat litter boxes are configured to hold cat litter for urination and defecation of cats. In the prior art, a silicone bin is generally placed inside a conventional cat litter box to hold the cat litter. On the one hand, the silicone is soft, making a process of urination and defecation comfortable for the cats. On the other hand, the silicone bin facilitates subsequent cleaning of the conventional cat litter box. However, the silicone bin in the prior art is placed directly inside the conventional cat litter box, and an edge of the silicone bin protrudes from an inner wall of the conventional cat litter box, which hinders cat feces to slide down an inner wall of the conventional cat litter box and may further cause the cat urine to flow out along the edge of the silicone bin.

### SUMMARY

To solve defects in the prior art, the present disclosure provides a cat litter bin of a cat litter box and the cat litter box.

The cat litter bin of the present disclosure comprises a main bin body, a bin bottom shell, and a silicone bin. An opening is defined in a bottom portion of the main bin body. The bin bottom shell comprises a cover. A sealing flange extends out of the silicone bin along an edge of the silicone bin. The silicone bin is disposed on the bin bottom shell. Side walls of the cover of the bin bottom shell abut against a bottom portion of the sealing flange. When the bin bottom shell covers the opening, a top portion of the sealing flange abuts against side walls of the opening.

The opening comprises a first plugging flange extending toward the sealing flange. The sealing flange comprises a first plugging groove corresponding to the first plugging flange. When the top portion of the sealing flange abuts against the side walls of the opening, the first plugging flange is plugged into the first plugging groove.

Outer walls of the first plugging flange are tightly attached to inner walls of the first plugging groove.

A sealing ring is disposed at the bottom portion of the sealing flange, and the side walls of the cover abut against the sealing ring.

The sealing flange comprises a second plugging flange extending toward the sealing ring. The sealing ring comprises a second plugging groove. The second plugging flange is plugged into the second plugging groove.

Snapping fasteners are disposed on a bottom portion of the second plugging flange. Snapping holes are defined in a bottom wall of the second plugging groove. The snapping fasteners are snapped in the snapping holes, so that the sealing flange is fastened to the sealing ring.

The cat litter bin further comprises screws. Each of the screws passes through a corresponding one of the side walls of the cover, the sealing ring and the sealing flange in sequence and is screwed with a corresponding one of the side walls of the opening, so that the bin bottom shell covers the opening of the main bin body.

When the bin bottom shell covers the opening of the main bin body, an inner wall of the silicone bin does not protrude from an inner wall of the main bin body.

The inner wall of the silicone bin is flush with the inner wall of the main bin body, so that the inner wall of the main bin body smoothly transitions with the inner wall of the silicone bin.

The present disclosure provides the cat litter box. The cat litter box comprises the cat litter bin described above.

By such configurations, when in use, cat litter is placed in the silicone bin. Since the side walls of the opening abut against the top portion of the sealing flange of the silicone bin, the side walls of the cover abut against the bottom portion of the sealing flange of the silicone bin, a sealed installation of the silicone bin is realized, and cat urine is effectively prevented from flowing out of the cat litter bin. Moreover, in the cat litter bin, the inner wall of the silicone bin does not protrude from the inner wall of the main bin body. In particular, the inner wall of the silicone bin is flush with the inner wall of the main bin body, so that the inner wall of the main bin body and the inner wall of the silicone bin smoothly transition. In this way, the cat urine and cat feces are allowed to smoothly slide down along the inner wall of the main bin body into the silicone bin, which facilitates the collection of the cat urine and the cat feces.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a schematic diagram of a cat little box according to one embodiment of the present disclosure.

FIG. 2 is a schematic diagram of a cat litter bin according to one embodiment of the present disclosure.

FIG. 3 is an exploded schematic diagram of the cat little bin shown in FIG. 2.

FIG. 4 is a cross-sectional schematic diagram of a cat litter bin according to one embodiment of the present disclosure.

FIG. 5 is an enlarged schematic diagram of portion A shown in FIG. 4.

FIG. 6 is a schematic diagram of a silicone bin according to one embodiment of the present disclosure, where a sealing ring thereof is removed.

FIG. 7 is an enlarged schematic diagram of portion B shown in FIG. 6.

### DETAILED DESCRIPTION

### Embodiment 1

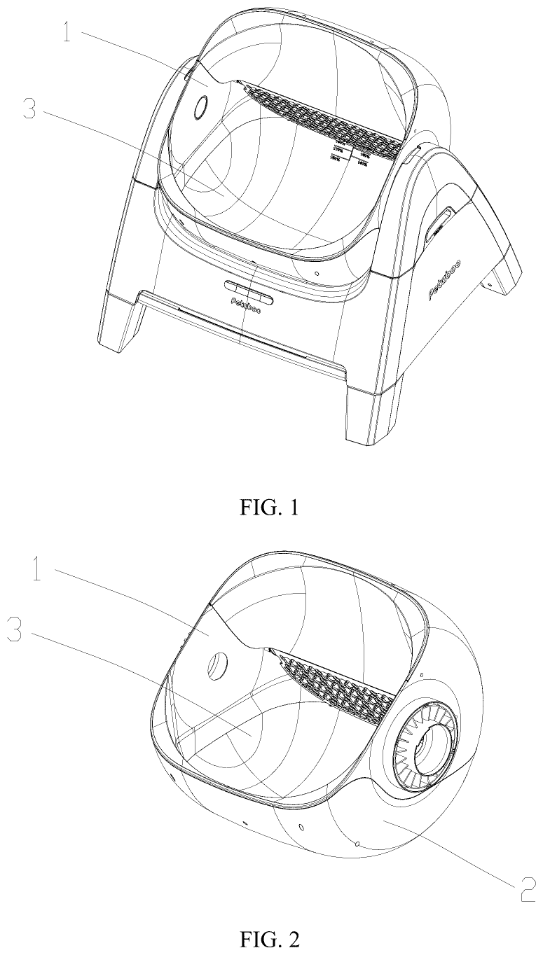

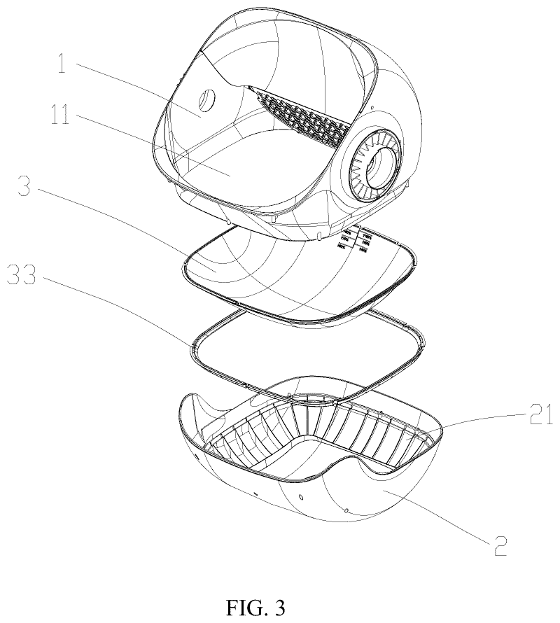

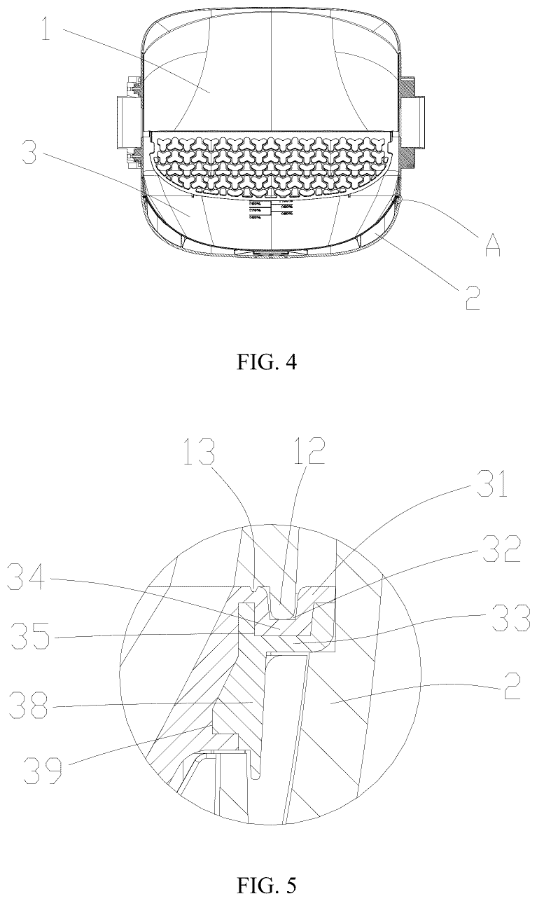

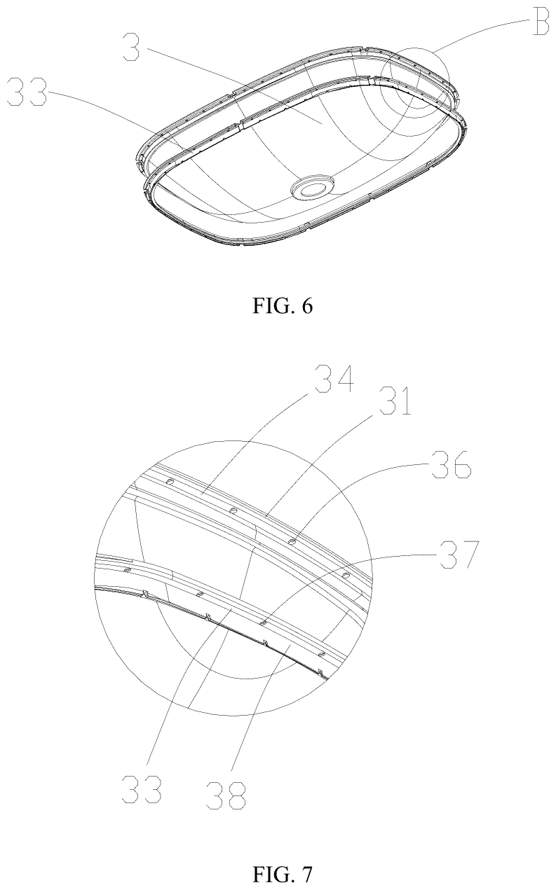

As shown in FIGS. 1-7, a cat litter bin of the present disclosure comprises a main bin body 1, a bin bottom shell 2, and a silicone bin 3. An opening 11 is defined in a bottom portion of the main bin body 1. The bin bottom shell 2 comprises a cover 21. The silicone bin comprises a sealing flange 31 extending along an edge of the silicone bin 3. The silicone bin 3 is disposed on the bin bottom shell 2. Side walls of the cover of the bin bottom shell 2 abut against a bottom portion of the sealing flange 31. When the bin bottom shell 2 covers the opening 11, a top portion of the sealing flange 31 abuts against side walls of the opening 11.

By such configurations, when in use, cat litter is placed in the silicone bin 3. Since the side walls of the opening 11 abut against the top portion of the sealing flange 31 of the silicone bin 3, the side walls of the cover abut against the bottom portion of the sealing flange 31 of the silicone bin 3, a sealed installation of the silicone bin 3 is realized, and cat urine is effectively prevented from flowing out of the cat litter bin. Moreover, in the cat litter bin, the inner wall of the silicone bin 3 does not protrude from the inner wall of the main bin body 1. In particular, the inner wall of the silicone bin 3 is flush with the inner wall of the main bin body 1, so that the inner wall of the main bin body 1 and the inner wall of the silicone bin 3 smoothly transition. In this way, the cat urine and cat feces are allowed to smoothly slide down along the inner wall of the main bin body 1 into the silicone bin 3, which facilitates the collection of the cat urine and the cat feces.

In the embodiment, the opening 11 comprises a first plugging flange 12 extending toward the sealing flange 31. The sealing flange 31 comprises a first plugging groove 32 corresponding to the first plugging flange 12. When the top portion of the sealing flange 31 abuts against the side walls of the opening 11, the first plugging flange 12 is plugged into the first plugging groove 32.

Furthermore, outer walls of the first plugging flange 12 are tightly attached to inner walls of the first plugging groove 32, enhancing the seal between the side walls of the opening and the side walls of the sealing flange, thereby better preventing leakage. A structure thereof is simple and reliable. Furthermore, abutting protrusions 13 extend from the side walls of the opening. The abutting protrusions are configured to abut against the sealing flange to enhance sealing performance.

In the embodiment, a sealing ring 33 is disposed at the bottom portion of the sealing flange 31, and the side walls of the cover 21 abut against the sealing ring 33.

The sealing flange 31 comprises a second plugging flange 34 extending toward the sealing ring 33. The sealing ring 33 comprises a second plugging groove 35. The second plugging flange 34 is plugged into the second plugging groove 35. Furthermore, outer walls of the second plugging flange are tightly attached to inner walls of the second plugging groove, so that sealing performance between the sealing flange and the sealing ring is enhanced, leakage is effectively prevented, and structures thereof are simple and reliable.

Furthermore, snapping fasteners 36 are disposed on a bottom portion of the second plugging flange 34. Snapping holes 37 are defined in a bottom wall of the second plugging groove 35. The snapping fasteners 36 are snapped in the snapping holes 37, so that the sealing flange 31 is fastened to the sealing ring 33. Structures thereof are simple and reliable.

Furthermore, the sealing ring extends downward to form an embedding portion 38, and an embedding groove 39 is defined on the side walls of the silicone bin. The embedding portion 38 is embedded in and fits in the embedding groove 39 to improve the sealing performance of the silicone bin.

In the embodiment, the cat litter bin further comprises screws (not shown in the drawings). Each of the screws passes through a corresponding one of the side walls of the cover 21, the sealing ring 33 and the sealing flange 31 in sequence and is screwed with a corresponding one of the side walls of the opening 11, so that the bin bottom shell 2 covers the opening 11 of the main bin body 1. Structures thereof are simple and are easy to assemble.

In the embodiment, when the bin bottom shell 2 covers the opening 11 of the main bin body 1, an inner wall of the silicone bin 3 does not protrude from an inner wall of the main bin body 1. Furthermore, the inner wall of the silicone bin 3 is flush with the inner wall of the main bin body 1, so that the inner wall of the main bin body 1 smoothly transitions with the inner wall of the silicone bin 3. In this way, the cat urine and the cat feces are allowed to smoothly slide down along the inner wall of the main bin body 1 into the silicone bin 3, which facilitates the collection of the cat urine and the cat feces.

### Embodiment 2

As shown in FIGS. 1-5, the present disclosure provides a cat litter box. The cat litter box comprises the cat litter bin described above.

The cat litter box comprises the cat litter bin described above. When in use, the cat litter is placed in the silicone bin 3. Since the side walls of the opening 11 abut against the top portion of the sealing flange 31 of the silicone bin 3, the side walls of the cover abut against the bottom portion of the sealing flange 31 of the silicone bin 3, the sealed installation of the silicone bin 3 is realized, and the cat urine is effectively prevented from flowing out of the cat litter bin. Moreover, in the cat litter bin, the inner wall of the silicone bin 3 does not protrude from the inner wall of the main bin body 1. In particular, the inner wall of the silicone bin 3 is flush with the inner wall of the main bin body 1, so that the inner wall of the main bin body 1 and the inner wall of the silicone bin 3 smoothly transition. In this way, the cat urine and cat feces are allowed to smoothly slide down along the inner wall of the main bin body 1 into the silicone bin 3, which facilitates the collection of the cat urine and the cat feces.

The above descriptions provide one or more embodiments in conjunction with the specific content, and specific implementations of the present disclosure are not limited thereto. Any similarity or similarity with the methods, structures, etc. of the present disclosure, or any technical deduction or substitution based on the concept of the present disclosure, shall be deemed to be within the protection scope of the present disclosure.

What is claimed is:

1. A cat litter bin of a cat litter box, comprising:
a main bin body;
a bin bottom shell; and
a silicone bin;
wherein an opening is defined in a bottom portion of the main bin body, the bin bottom shell comprises a cover, a sealing flange extends out of the silicone bin along an edge of the silicone bin, the silicone bin is disposed on the bin bottom shell, side walls of the cover of the bin bottom shell abut against a bottom portion of the sealing flange, and when the bin bottom shell covers the opening, a top portion of the sealing flange abuts against side walls of the opening.

2. The cat litter bin according to claim 1, wherein the opening comprises a first plugging flange extending toward the sealing flange, the sealing flange comprises a first plugging groove corresponding to the first plugging flange, and when the top portion of the sealing flange abuts against the side walls of the opening, the first plugging flange is plugged into the first plugging groove.

3. The cat litter bin according to claim 2, wherein outer walls of the first plugging flange are tightly attached to inner walls of the first plugging groove.

4. The cat litter bin according to claim 1, wherein a sealing ring is disposed at the bottom portion of the sealing flange, and the side walls of the cover abut against the sealing ring.

5. The cat litter bin according to claim 4, wherein the sealing flange comprises a second plugging flange extending toward the sealing ring, the sealing ring comprises a second plugging groove, and the second plugging flange is plugged into the second plugging groove.

6. The cat litter bin according to claim 5, wherein snapping fasteners are disposed on a bottom portion of the second plugging flange, snapping holes are defined in a bottom wall of the second plugging groove, and the snapping fasteners are snapped in the snapping holes, so that the sealing flange is fastened to the sealing ring.

7. The cat litter bin according to claim 4, wherein the cat litter bin further comprises screws, each of the screws passes through a corresponding one of the side walls of the cover, the sealing ring and the sealing flange in sequence and is screwed with a corresponding one of the side walls of the opening, so that the bin bottom shell covers the opening of the main bin body.

8. The cat litter bin according to claim 1, wherein when the bin bottom shell covers the opening of the main bin body, an inner wall of the silicone bin does not protrude from an inner wall of the main bin body.

9. The cat litter bin according to claim 8, wherein the inner wall of the silicone bin is flush with the inner wall of the main bin body, so that the inner wall of the main bin body smoothly transitions with the inner wall of the silicone bin.

10. A cat litter box, comprising: the cat litter bin according to claim 1.
